(19) United States
(12) Patent Application Publication
(10) Pub. No.: US 2015/0339710 A1
(43) Pub. Date: Nov. 26, 2015

(54) SOCIAL NETWORKING BASED OFFERS

(71) Applicants: Dennis Landscheidt, Mannheim (DE); Marc-Oliver Klein, Mannheim (DE)

(72) Inventors: Dennis Landscheidt, Mannheim (DE); Marc-Oliver Klein, Mannheim (DE)

(21) Appl. No.: 14/284,587

(22) Filed: May 22, 2014

(51) Int. Cl. G06Q 30/02; G06Q 50/18; G06Q 50/00

(52) U.S. Cl. CPC G06Q 30/0254; G06Q 50/01; G06Q 50/188

(57) ABSTRACT

Techniques for providing social networking based offers, including identifying a particular user that is a customer of a service provider; identifying one or more other users that are socially connected to the particular user through at least one social network; generating, by the service provider, a master social plan for the particular user and a subset of the one or more other users, the master social plan identifying a business model between (i) each of the particular user and the subset of the one or more other users and (ii) the service provider; and providing an offer associated with the master social plan to the subset of the one or more other users.

### TECHNICAL BACKGROUND

This disclosure relates to providing social networking based offers.

### BACKGROUND

Service companies, such as utility and telecommunication companies, are exploring new avenues to attract new customers and retain existing customers. Additionally, service companies are increasingly offering more and more social components into their product portfolio. Service companies may use social networking to promote the provided services.

### SUMMARY

The present disclosure relates to computer-implemented methods, software, and systems for providing social networking based offers. In some implementations, a particular user is identified that is a customer of a service provider; one or more other users are identified that are socially connected to the particular user through at least one social network; a master social plan is generated, by the service provider, for the particular user and a subset of the one or more other users, the master social plan identifying a business model between (i) each of the particular user and the subset of the one or more other users and (ii) the service provider; and an offer associated with the master social plan is provided to the subset of the one or more other users.

Other general implementations include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

In a first aspect combinable with any of the general implementations, in response to providing the offer, receiving, from one or more other users of the subset of the one or more other users, one or more personalized settings associated with the master social plan; and generating, for each of the one or more other users of the subset of the one or more other users, a dependent social plan based on (i) the master social plan and (ii) the one or more personalized settings for the other user.

In a second aspect combinable with any of the previous aspects, wherein the one or more personalized settings associated with a first other user of the one or more other users of the subset of the one or more other users is different from the one or more personalized settings associated with a second other user of the one or more other users of the subset of the one or more other users.

In a third aspect combinable with any of the previous aspects, wherein generating the dependent social plan further includes generating, for the first other user, a first dependent social plan based on (i) the master social plan and (ii) the one or more personalized settings associated with the first other user; generating, for the second other user, a second dependent social plan based on (i) the master social plan and (ii) the one or more personalized settings associated with the second other user, wherein the first dependent social plan is different from the second dependent social plan.

In a fourth aspect combinable with any of the previous aspects, wherein the one or more personalized settings associated with the master social plan includes one or more modifications of one or more characteristics of the master social plan.

In a fifth aspect combinable with any of the previous aspects, receiving, from each of the one or more other users of the subset of the one or more other users, an acceptance of a contract associated with the offer between the other user and the service provider; and storing, in a database, an association between each of the one or more other users of the subset of the one or more other users and the particular user, the association indicating the acceptance of the contract associated with the offer.

In a sixth aspect combinable with any of the previous aspects, identifying an additional subset of the one or more other users that are socially connected to the particular user, the additional subset of the one or more other users exclusive of the one or more other users of the subset of the one or more other users that accepted the contract associated with the offer; and providing the offer associated with the master social plan to the additional subset of the one or more other users.

In a seventh aspect combinable with any of the previous aspects, identifying a number of generated dependent social plans; and associating a financial discount with the master social plan based on the number of generated dependent social plans.

In an eighth aspect combinable with any of the previous aspects, wherein the offer includes (i) the master social plan and (ii) one or more personalization options.

In a ninth aspect combinable with any of the previous aspects, wherein identifying the one or more other users that are socially connected to the particular user through the at least one social network further includes identifying a social network graph associated with the particular user and corresponding to the at least one social network; and identifying the one or more other users that are socially connected to the particular user based on the social network graph.

In a tenth aspect combinable with any of the previous aspects, wherein providing the offer associated with the master social plan to the subset of the one or more other users further includes providing the offer through the at least one social network.

In an eleventh aspect combinable with any of the previous aspects, wherein providing the offer through the at least one social network includes modifying a social network stream of items of digital content to include an additional item of digital content associated with the offer.

In a twelfth aspect combinable with any of the previous aspects, wherein the customer is a current customer of the service provider.

In a thirteenth aspect combinable with any of the previous aspects, wherein the customer is a potential customer of the service provider.

In a fourteenth aspect combinable with any of the previous aspects, providing the offer associated with the master plan to the potential customer of the service provider.

In a fifteenth aspect combinable with any of the previous aspects, wherein identifying the one or more other users that are socially connected to the particular user through the at least one social network further includes identifying, for each other user of the one or more other users, a social score of each other user with respect to the particular user; comparing the social score of each other user of the one or more other users with a social threshold score; and based on the comparing, identifying the subset of the one or more other users having a social score greater than the social threshold score.

In a sixteenth aspect combinable with any of the previous aspects, wherein the social score, for each other user of the one or more other users, is based on a number of social interactions between the other user and the particular user and a type of the social interactions between the other user and the particular user.

Various implementations of a computing system according to the present disclosure may have one or more of the following features. For example, by binding families, friends, and networks to one contract, customer churn is reduced while increasing revenues for service companies offering social plans. Higher buying power of social communities is increased by adding connectors to the social communities.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example distributed computing system for providing social networking based offers.

FIG. 2 illustrates an example architecture of a master social plan and dependent social plans.

FIG. 3 illustrates an example system for providing social networking based offers.

FIG. 4 illustrates an example use-case example architecture of a master social plan and dependent social plans.

FIG. 5 illustrates a flow chart of a method for providing social networking based offers.

FIG. 6 illustrates a flow chart of a method for providing closed-loop social networking based offers.

### DETAILED DESCRIPTION

In some implementations, social networking based offers are provided. In some examples, a user is identified that is a customer (potential or current) of a service provider. Other users are identified that are socially connected to the particular user. For example, the other users are “friends” of the particular user via a social networking service. A master social plan is generated for the user and other users that are socially connected to the particular user. In some examples, the master social plan identifies a business model that is defined between (i) the particular user and the other users that are socially connected to the particular user and (ii) the service provider. An offer associated with the master social plan is then provided to the other users that are socially connected to the particular user.

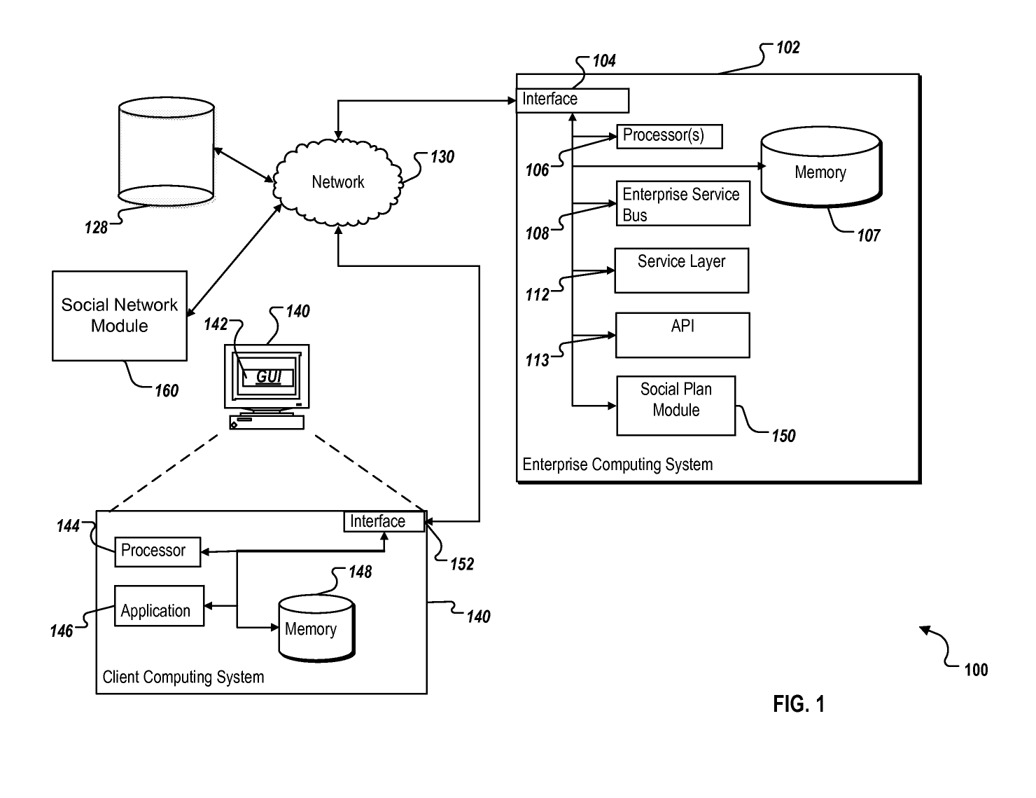

FIG. 1 illustrates an example distributed computing system 100 for providing social networking based offers. In some examples, the illustrated enterprise server computing system 102 may store a plurality of various hosted applications, while in some examples, the enterprise server computing system 102 may be a dedicated server meant to store and execute only a single hosted application. In some instances, the enterprise server computing system 102 may comprise a web server, where the hosted applications represent one or more web-based applications accessed and executed via the network 130 by the client computing system 140 to perform the programmed tasks or operations of the hosted application.

At a high level, the illustrated enterprise server computing system 102 comprises an electronic computing device operable to receive, transmit, process, store, or manage data and information associated with the distributed computing system 100. Specifically, the enterprise server computing system 102 illustrated in FIG. 1 is responsible for receiving application requests from one or more client applications associated with the client computing system 140 of the distributed computing system 100 and responding to the received requests by processing said requests in the associated hosted application, and sending the appropriate response from the hosted application back to the requesting client application. In addition to requests from the client computing system 140 illustrated in FIG. 1, requests associated with the hosted applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single enterprise server computing system 102, the distributed computing system 100 can be implemented using two or more servers, as well as computers other than servers, including a server pool. In some examples, the enterprise server computing system 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the enterprise server computing system 102 may be adapted to execute any operating system, including Linux, UNIX, Windows, Mac OS, or any other suitable operating system.

The system 100 includes a social plan module 150. In an overview, the social plan module 150 identifies a user and social connections of the user, generates a master social plan for the user and the social connections of the user, and provides an offer of the master social plan to the social connections of the user. The social plan module 150 can obtain information regarding the social connections of the user from a social network module 160, described further below.

The illustrated enterprise server computing system 102 further includes an interface 104. Although illustrated as a single interface 104 in FIG. 1, two or more interfaces 104 may be used according to particular needs, desires, or particular implementations of the example distributed computing system 100. The interface 104 is used by the enterprise server computing system 102 for communicating with other systems in a distributed environment—including within the example distributed computing system 100—connected to the network 130; for example, the client computing system 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

Regardless of the particular implementation, “software” may include computer-readable instructions, firmware, wired or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, ABAP, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The illustrated enterprise server computing system 102 further includes a processor 106. Although illustrated as a single processor 106 in FIG. 1, two or more processors may be used according to particular needs, desires, or particular implementations of the example distributed computing system 100. The processor 106 may be a central processing unit (CPU), a blade, an application specific integrated circuit (ASIC), a field-programmable gate array (FPGA), or another suitable component. Generally, the processor 106 executes instructions and manipulates data to perform the operations of the enterprise server computing system 102. Specifically, the processor 106 executes the functionality required to receive and respond to requests from the client computing system 140.

The illustrated enterprise server computing system 102 also includes a memory 107. Although illustrated as a single memory 107 in FIG. 1, two or more memories may be used according to particular needs, desires, or particular implementations of the example distributed computing system 100. In some implementations, the memory 107 is an in-memory database. While memory 107 is illustrated as an integral component of the enterprise server computing system 102, in some implementations, the memory 107 can be external to the enterprise server computing system 102 and/or the example distributed computing system 100. The memory 107 may include any memory or database module and may take the form of volatile or non-volatile memory including, without limitation, magnetic media, optical media, random access memory (RAM), read-only memory (ROM), removable media, or any other suitable local or remote memory component. The memory 107 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the enterprise computing system 102. Additionally, the memory 107 may include any other appropriate data, such as VPN applications, firmware logs and policies, firewall policies, a security or access log, print or other reporting files, as well as others.

The illustrated enterprise server computing system 102 further includes a service layer 112. The service layer 112 provides software services to the example distributed computing system 100. The functionality of the enterprise server computing system 102 may be accessible for all service consumers using this service layer. For example, in one implementation, the client computing system 140 can utilize the service layer 112 to communicate with the design engine 118. Software services provide reusable, defined business functionalities through a defined interface. For example, the interface may be software written in extensible markup language (XML) or other suitable language. While illustrated as an integrated component of the enterprise server computing system 102 in the example distributed computing system 100, alternative implementations may illustrate the service layer 112 as a stand-alone component in relation to other components of the example distributed computing system 100. Moreover, any or all parts of the service layer 112 may be implemented as child or sub-modules of another software module, enterprise application, or hardware module without departing from the scope of this disclosure.

The illustrated enterprise server computing system 102 further includes an application programming interface (API) 113. In some implementations, the API 113 can be used to interface between the design engine 118 and one or more components of the enterprise server computing system 102 or other components of the example distributed computing system 100, both hardware and software. For example, in some implementations, the design engine 118 can utilize the API 113 to communicate with the client computing system 140. The API 113 may include specifications for routines, data structures, and object classes. The API 113 may be either computer language independent or dependent and refer to a complete interface, a single function, or even a set of APIs. While illustrated as an integrated component of the enterprise server computing system 102 in the example distributed computing system 100, alternative implementations may illustrate the API 113 as a stand-alone component in relation to other components of the example distributed computing system 100. Moreover, any or all parts of the API 113 may be implemented as child or sub-modules of another software module, enterprise application, or hardware module without departing from the scope of this disclosure.

The client computing system 140 may be any computing device operable to connect to or communicate with at least the enterprise server computing system 102 using the network 130. In general, the client computing system 140 comprises a computer operable to receive, transmit, process, and store any appropriate data associated with the example distributed computing system 100. The illustrated client computing system 140 further includes an application 146. The application 146 is any type of application that allows the client computing system 140 to request and view content on the client computing system 140. In some implementations, the application 146 can be and/or include a web browser. In some implementations, the application 146 can use parameters, metadata, and other information received at launch to access a particular set of data from the enterprise server computing system 102. Once a particular application 146 is launched, a user may interactively process a task, event, or other information associated with the enterprise server computing system 102. Further, although illustrated as a single application 146, the application 146 may be implemented as multiple applications in the client computing system 140.

The illustrated client computing system 140 further includes an interface 152, a processor 144, and a memory 148. The interface 152 is used by the client computing system 140 for communicating with other systems in a distributed environment—including within the example distributed computing system 100—connected to the network 130; for example, the enterprise server computing system 102 as well as other systems communicably coupled to the network 130 (not illustrated). The interface 152 may also be consistent with the above-described interface 104 of the enterprise server computing system 102 or other interfaces within the example distributed computing system 100.

The processor 144 may be consistent with the above-described processor 106 of the enterprise server computing system 102 or other processors within the example distributed computing system 100. Specifically, the processor 144 executes instructions and manipulates data to perform the operations of the client computing system 140, including the functionality required to send requests to the enterprise server computing system 102 and to receive and process responses from the enterprise server computing system 102. The memory 148 may be consistent with the above-described memory 107 of the enterprise server computing system 102 or other memories within the example distributed computing system 100 but storing objects and/or data associated with the purposes of the client computing system 140.

Further, the illustrated client computing system 140 includes a GUI 142. The GUI 142 interfaces with at least a portion of the example distributed computing system 100 for any suitable purpose, including generating a visual representation of a web browser. In particular, the GUI 142 may be used to view and navigate various web pages located both internally and externally to the enterprise server computing system 102. Generally, through the GUI 142, an enterprise server computing system 102 user is provided with an efficient and user-friendly presentation of data provided by or communicated within the example distributed computing system 100.

There may be any number of client computing systems 140 associated with, or external to, the example distributed computing system 100. For example, while the illustrated example distributed computing system 100 includes one client computing system 140 communicably coupled to the enterprise server computing system 102 using network 130, alternative implementations of the example distributed computing system 100 may include any number of client computing systems 140 suitable for the purposes of the example distributed computing system 100. Additionally, there may also be one or more client computing systems 140 external to the illustrated portion of the example distributed computing system 100 that are capable of interacting with the example distributed computing system 100 using the network 130. Moreover, while the client computing system 140 is described in terms of being used by a single user, this disclosure contemplates that many users may use one computer, or that one user may use multiple computers.

The illustrated client computing system 140 is intended to encompass any computing device such as a desktop computer, laptop/notebook computer, wireless data port, smart phone, personal data assistant (PDA), tablet computing device, one or more processors within these devices, or any other suitable processing device. For example, the client computing system 140 may comprise a computer that includes an input device, such as a keypad, touch screen, or other device that can accept user information, and an output device that conveys information associated with the operation of the enterprise server computing system 102 or the client computing system 140 itself, including digital data, visual information, or a GUI 142, as shown with respect to the client computing system 140.

The illustrated distributed computing system 100 further includes a repository 128. In some implementations, the repository 128 is an in-memory repository. In some examples, the in-memory repository may include integrated processing. In some examples, the in-memory repository may reside on top of a computational engine that facilitates fast manipulations on large amounts of data and/or replication of data. The repository 128 can be a cloud-based storage medium. For example, the repository 128 can be networked online storage where data is stored on virtualized pools of storage.

With respect to the network 130, generally, the illustrated network 130 facilitates wireless or wireline communications between the components of the distributed computing system 100 (e.g., between the computing systems 102 and 140), as well as with any other local or remote computer, such as additional clients, servers, or other devices communicably coupled to network 130 but not illustrated in FIG. 1. The network 130 is illustrated as a single network in FIG. 1, but may be a continuous or discontinuous network without departing from the scope of this disclosure, so long as at least a portion of the network 130 may facilitate communications between senders and recipients. The network 130 may be all or a portion of an enterprise or secured network, while in another instance at least a portion of the network 130 may represent a connection to the Internet.

In some instances, a portion of the network 130 may be a virtual private network (VPN), such as, for example, the connection between the client computing system 140 and the enterprise server computing system 102. Further, all or a portion of the network 130 can comprise either a wireline or wireless link. Example wireless links may include 802.11a/b/g/n, 802.20, WiMax, and/or any other appropriate wireless link. In other words, the network 130 encompasses any internal or external network, networks, sub-network, or combination thereof operable to facilitate communications between various computing components inside and outside the illustrated distributed computing system 100. The network 130 may communicate, for example, Internet Protocol (IP) packets, Frame Relay frames, Asynchronous Transfer Mode (ATM) cells, voice, video, data, and other suitable information between network addresses. The network 130 may also include one or more local area networks (LANs), radio access networks (RANs), metropolitan area networks (MANs), wide area networks (WANs), all or a portion of the Internet, and/or any other communication system or systems at one or more locations.

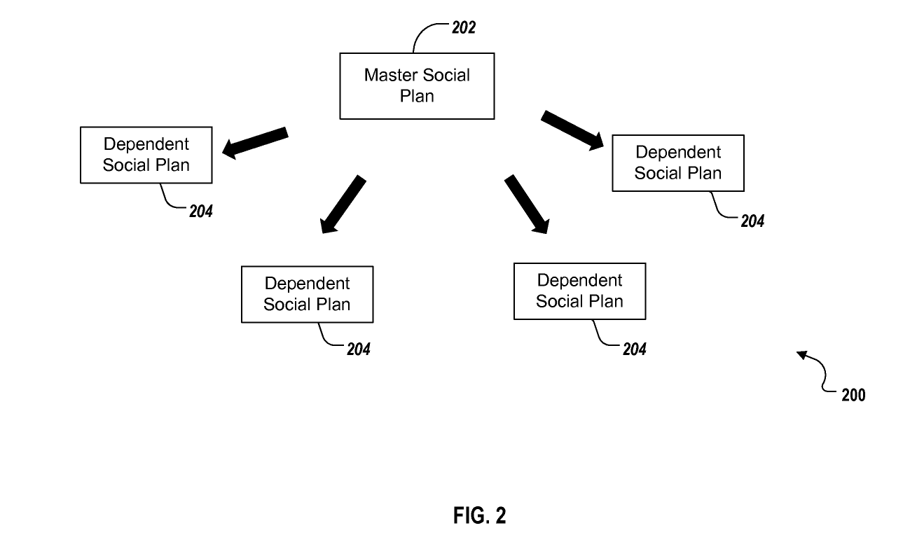

FIG. 2 illustrates an example architecture 200 of a master social plan 202 and dependent social plans 204. Specifically, in some examples, the master social plan 202 is a business model between a service provider and one or more customers of the service provider. The master social plan 202 can include one or more characteristics that define one or more aspects of the business model. In some examples, the characteristics can include, among other things, the specific users to associate with the master social plan 202, a pricing structure associated with the master social plan 202, a maximum number of members allowed for association with the master social plan 202, and benefits of the master social plan 202 between members.

In some examples, each the dependent social plans 204 is a modified business plan between the service provider and the respective customer of the service provider associated with the dependent social plan 204. Specifically, the dependent social plans 204 are each based on or derived from the master social plan 202 and incorporate characteristics associated with the master social plan 202. That is, the master social plan 202 can be used as a base plan, and the dependent social plans 204 can share a set of common characteristics associated with the base plan, and additionally one or more modifications of the characteristics associated with (or identified by) individual customers associated with the particular dependent plans. For example, the dependent social plans 204 can include additional pricing structures associated with the master social plan 202. Additionally, in some examples, each of the dependent social plans 204 are associated with and incorporate personalized settings modifying or adding on to the associated master social plan 202. For example, the personalized settings can include modifications of the characteristics associated with the master social plan 202. In some examples, the dependent social plans 204 can be modified initially, e.g., upon generation of the dependent social plans 204, or at a later time. In some examples, each of the dependent social plans is associated with a differing user that is a current and/or potential customer of the service provider. In some examples, each of the users associated with the master social plan 202 and the dependent social plans 204 are socially connected through one or more social networks.

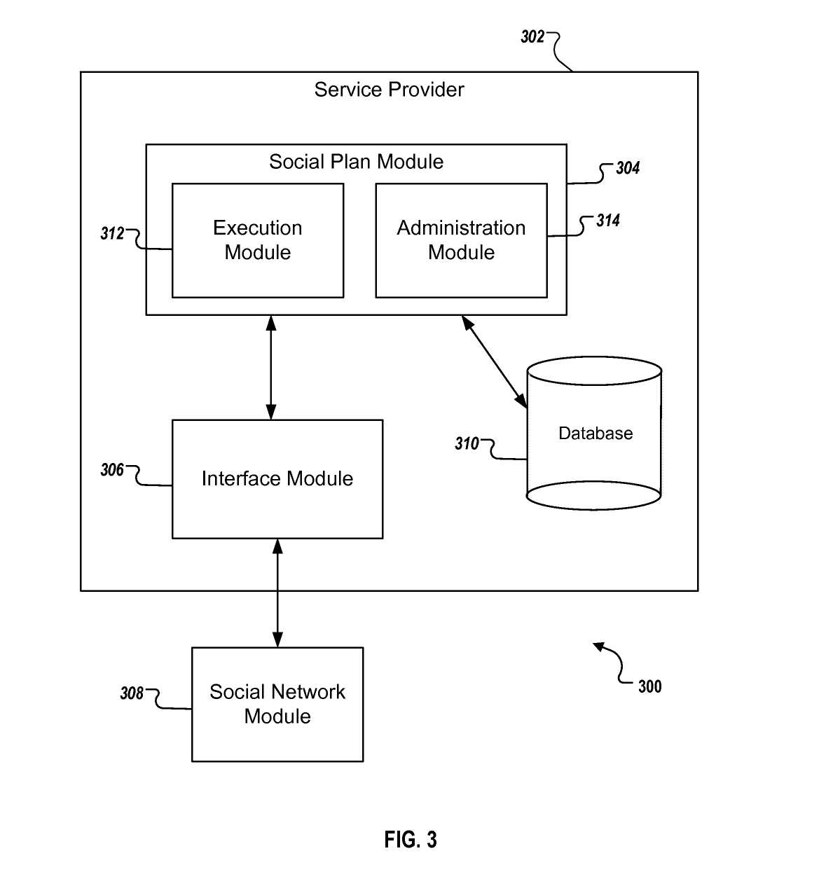

FIG. 3 illustrates an example system 300 for providing social networking based offers. System 300 includes a service provider 302 and a social network module 308. The service provider 302 includes a social plan module 304, an interface module 306, and a database 310. The social plan module 304 includes an execution module 312 and an administration module 314. In some examples, the social plan module 304 is substantially the same as the social plan module 150 of FIG. 1 and the social network module 308 is substantially the same as the social network module 160 of FIG. 1.

The service provider 302, as mentioned above, provides a service, e.g., to one or more customers, or to a third party. For example, the service can include a telecommunication service, e.g., a wireless telecommunications service. The social plan module 304, and specifically, the execution module 312 and the administration module 314, is in communication (e.g., over the network 130) with the interface module 306 and the database 310. Additionally, the interface module 306 is in communication (e.g., over the network 130) with the social plan module 304 and the social network module 308. In some examples, the interface module 306 includes the database 310, or is in communication with (e.g., over the network 130) with the database 310. In some implementations, the repository database 310 is an in-memory database. In some examples, the social network module 308 can include a representation of one or more social networking services, or an interface (e.g., API) to data provided by the social networking services.

In some implementations, a particular user is identified as a customer of the service provider 302. Specifically, in some examples, the service provider 302 identifies the particular user as a current customer of the service provider 302. In some examples, the particular user is a potential customer of the service provider 302.

In some implementations, one or more other users are identified that are socially connected to the particular user through at least one social network. For example, types of social connections between the other users and the particular user can include the other user being a follower of the particular user through a photo sharing service (e.g., Instagram); a friend of the particular user on a social networking service (e.g., Facebook); a connection of the particular user on a professional social networking service (e.g., LinkedIn); and/or a member of a circle of the particular on a social networking service (e.g., Google+). In some examples, the social plan module 304, and specifically, the administration module 314, identifies the other users that are socially connected to the particular user through the at least one social network. To that end, the interface module 306 is in communication with the social network module 308. The administration module 314 can obtain social network data associated with the particular user from the social network module 308 via the interface module 306 (e.g., through one or more APIs). The social network data associated with the particular user can include social media metadata of the particular user, including metadata associated with a listing of other users that are socially connected to the particular user (e.g., the other users are “friends” with the particular user or are “followers” of the particular user). In some examples, the obtained social media metadata associated with the particular user is stored in the database 310.

In some examples, a social network graph associated with the particular user and corresponding to the at least one social network is identified. Specifically, the interface module 306 is connected to a social network graph API of the social network module 308. The administration module 314 obtains the social network graph information from the interface module 306. In some examples, the social network graph includes a representation (e.g., graphical) of one or more other users (e.g., users of the social network) that are socially connected to the particular user. In some examples, the other users include directly connected other users (e.g., one-hop connections). In some examples, the other users can include indirectly connected other users (e.g., two-hop or more connections). In some examples, the one or more other users that are socially connected to the particular user are identified based on the social network graph. In some of those instances, the administration module 314 can identify a listing of the one or more other user based on the social network graph. In some examples, the social network graph provides the associated network structure for the particular user. Thus, by granting access to the social network graph of the particular user, the friends or followers of the particular user within the social network graph can be determined.

In some examples, a social score is identified for each of the other users with respect to the particular user. Specifically, each of the other users is associated with a social score (for the particular user) that indicates a social proximity between the other user and the particular user. In some examples, the social proximity represents a “friendship” level between the other user and the particular user. Thus, the higher the social score between the other user and the particular user, the closer the social proximity (e.g., as indicated in the social network graph of the particular user) between the other user and the particular user. Additionally, the lower the social score between the other user and the particular user, the further the social proximity (e.g., as indicated in the social network graph of the particular user) between the other user and the particular user.

In some examples, the social score for each other user is based on a number of social interactions between the other user and the particular user. In some examples, the social score for each user is based on a type of the social interactions between the other user and the particular user. For example, the social interactions can include social interactions through the social network between the other user and the particular user. Such interactions can include providing digital content by the other user to the particular user, e.g., posting a digital content item (e.g., text-based, photo-based, or video-based content item) on a newsfeed of the particular user; communicating and/or messaging between the other user and the particular user through the social network, e.g., instant-messaging; and the like.

In some examples, the social score of each other user (in view of the particular user) is compared with a social threshold score. Specifically, the administration module 314 can compare the social score of each other user with the social threshold score. The social threshold score can represent a desired “friendship” level between the other user and the particular user. Additionally, based on the comparing, a subset of the other users is identified that have a respective social score greater than the social threshold score.

In some implementations, a master social plan is generated for the particular user and a subset of the one or more other users. Specifically, in some examples, the execution module 312 generates the master social plan for the particular user. In some examples, the master social plan identifies a business model between (i) each of the particular user and the subset of the one or more other users and (ii) the service provider 302.

In some examples, the administration module 314 provides one or more rules associated with the generated master social plan. For example, a rule can relate to a categorization of the other users, and in particular, the administration module 314 can determine one or more categories of the other users socially connected to the particular user that are to be associated with the master social plan. The categories can include other users that are identified as family of the particular user (e.g., the particular user identifies one or more of the other users as family); friends of the particular user (e.g., the particular user identifies one or more of the other users as friends); and/or work colleagues of the particular user (e.g., the particular user identifies or more of the other users as work colleagues). However, other categorization of the other users that are socially connected to the particular user is possible. Additionally, in some examples, the rules can include a maximum number of other users to associate with the master social plan.

In some examples, the particular user provides input associated with the one or more rules. For example, the user input can include a category of other users socially connected to the particular user, or a maximum number of other users that are socially connected to the particular user to associate with the master social plan. In some examples, the rules can include a number of discounts associated with the master social plan. That is, each other user that accepts the master social plan, described further below, receives a discount (e.g., a discount from the pricing structure of the master social plan).

To that end, the execution module 312 processes the social media metadata associated with the particular user and the others users socially connected to the particular user and the rules provided by the administration module 312 to identify a subset of the other users to provide the master social plan to, described further below. In some examples, the execution module 312 compares the social metadata associated with the others users with the rules to determine which other users are eligible to receive the offer, described further below.

Additionally, the execution module 312 processes the social media metadata associated with the particular user and the others users socially connected to the particular user to determine the characteristics to associate with the master social plan. That is, the master social plan is associated with one or more characteristics that define the master social plan. For example, characteristics can include a pricing structure of the master social plan and differing options associated with the master social plan. For example, the master social plan can include a wireless telecommunications service master plan, and the characteristics can include a data plan rate, and the options can include an international data rate option, a messaging option (e.g., short message service, multimedia messaging service) etc.

In some examples, the execution module 312 processes the social media metadata associated with the particular user and the others users socially connected to the particular user to select a particular master social plan from a plurality of master social plans that are associated with the service provider 302. That is, the execution module 312 selects a most appropriate (or “best”) master social plan to provide the particular user and the other users socially connected to the particular user. Data associated with each of the plurality of master social plans can be stored by the database 310.

In some implementations, an offer associated with the master social plan is provided to the subset of the one or more other users. Specifically, the execution module 312 can provide the offer associated with the master social plan to the subset of the other users to the social network module 308 through the interface module 306. In some examples, providing the offer can include providing the offer through the social network. Specifically, the offer can include a web-based link (e.g., URL) directing the other users to a web resource associated with the offer. To that end, providing the offer through the social network can include modifying a social network stream of items of digital content that are typically associated with the other user. For example, the social network stream of items of digital content can include a newsfeed associated with the other user that displays digital content in a predetermined order (a chronological order, or an algorithm-based order). The digital content can include digital content provided by socially connected users to the other users (e.g., “friends” of the other user), as well as third-party entities. The digital content can include text, images, video, audio, and web-based links. In some examples, the offer can be provided through e-mail, text messaging, multimedia messaging, phone calls, applications, smartphone notifications, and blog posts.

Thus, the service provider 302 can provide the offer to the subset of the other users by modifying the social network stream of the items of digital content that is associated with each other user to include an additional item of digital content associated with the offer. In some examples, the interface module 306 provides an interface to a social network advertisement API provided by the social network module 308. Thus, the execution module 312 is able to provide the offer to the social network module 308 via the social network advertisement API.

In some examples, the offer includes (i) the master social plan and (ii) one or more personalization options. As mentioned above, the master social plan is associated with one or more characteristics. Thus, when providing the offer to the subset of the other users, the offer can include personalization options associated with the characteristics. Specifically, each of the other users is able to personalize the master social plan by modifying the master social plan to include personalized options, described further below.

In some examples, as mentioned above, the particular user is a potential customer of the service provider 302. Thus, in addition to, or in lieu of, providing the offer to the subset of the other users that are socially connected to the particular user, the offer also is provided to the particular user (e.g., via modification of a social network stream associated with the particular user to include digital content associated with the offer).

In some further implementations, in response to the providing the offer, one or more personalized settings associated with the master social plan are received from one or more other users that are provided the offer. Specifically, in some examples, the personalized settings can include modifications to the characteristics of the master social plan. For example, the other user can customize the master social plan (as allowed by rules associated with the master social plan) by modifying characteristics associated with the master social plan. For example, the master social plan can include a wireless telecommunications service. To that end, the personalized settings provided by the other users can include selection of a particular data rate plan of multiple data rate plans included by the master social plan.

In some examples, the personalized settings associated with a first other user of the subset of the other users are different from the personalized settings associated with a second other user of the subset of other users. For example, the particular data rate plan selected by the first other user can differ from a different data rate plan selected by the second other user.

In some further implementations, a dependent social plan is generated, for each of the other users of the subset, based on the (i) the master social plan and (ii) the personalized settings for the other user. Specifically, the execution module 312 processes the personalized setting for each of the other users and generates a corresponding dependent social plan for each of the other users. In some examples, the dependent social plan is a personalized master social plan that identifies a business model between the other user associated with the dependent social plan and the service provider 302. In some examples, the dependent social plan is dependent upon the master social plan in that the dependent social plan inherits (or includes) one or more characteristics from the master social plan. In some examples, one or more of the characteristics are non-customizable.

In some examples, two or more of the dependent social plans may be substantially the same (e.g., include substantially the same personalized settings). In some examples, two or more the dependent social plans may substantially differ (e.g., include different personalized settings). Specifically, the execution module 312 can generate, for the aforementioned first other user, a first dependent social plan that is based on the (i) the master social plan and (ii) the personalized settings associated with the first user; and further generate, for the aforementioned second other user, a second dependent social plan that is based on the (i) the master social plan and (ii) the personalized settings associated with the second other user. To that end, based on the personalized settings differing for the first and the second other user, the first dependent social plan is different from the second dependent social plan.

In some examples, subsequent to providing the offer to the subset of the other users that are socially connected to the particular user, an acceptance of a contract is received from one or more of the subset of the other users. For example, the contract is associated with the offer that is between the other user and the service provider 302. The contract can include an agreement such that the service provider 302 provides the service (e.g., a wireless telecommunications service) to the other user for financial compensation from the other user. However, other criteria for the contract are possible. In some examples, acceptance of the contract can include the service provider 302 receiving a signal from a client computing device (e.g., the client computing device 140) associated with the other user.

After receiving the acceptance of the contract from one or more of the subset of the other users, an association can be stored between the one or more of the subset of the other users and the particular user. For example, the association can indicate the acceptance of the contract associated with the offer by the other user. In some examples, the association can be stored in a table or a listing in the database 310. Thus, by storing such associations, the service provider 302 is able to determine which other users were provided the offer, and/or which other users that have accepted the offer that is associated with the particular user.

In some examples, an additional subset of the other users that are socially connected to the particular user are identified that are exclusive of the previous other users that accepted the offer. Specifically, the execution module 312 compares the other users that are socially connected to the particular user (e.g., as determined by the social network graph accessed from the social network module 308) with the other users that previously accepted the contract associated with the offer (e.g., as stored by the database 310). Based on the comparison, the execution module 312 is able to identify the additional subset of users that have not previously accepted the contract associated with the offer.

In some examples, the offer that is associated with the master plan is provided to the additional subset of the one or more other users. Specifically, the execution module 312 can provide the offer associated with the master social plan to the additional subset of the other users to the social network module 308 through the interface module 306. In some examples, providing the offer can include providing the offer through the social network. Specifically, the offer can include a web-based link (e.g., URL) directing the other users to a web resource associated with the offer. To that end, providing the offer through the social network can include modifying a social network stream of items of digital content that are typically associated with the other users. For example, the social network stream of items of digital content can include a newsfeed associated with the other user that displays digital content in a predetermined order (a chronological order, or an algorithm-based order). The digital content can include digital content provided by socially connected users to the other users (e.g., “friends” of the user), as well as third-party entities. The digital content can include text, images, video, audio, and web-based links. Thus, the service provider 302 can provide the offer to the subset of the other users by modifying the social network stream of the items of digital content that is associated with each user to include an additional item of digital content associated with the offer.

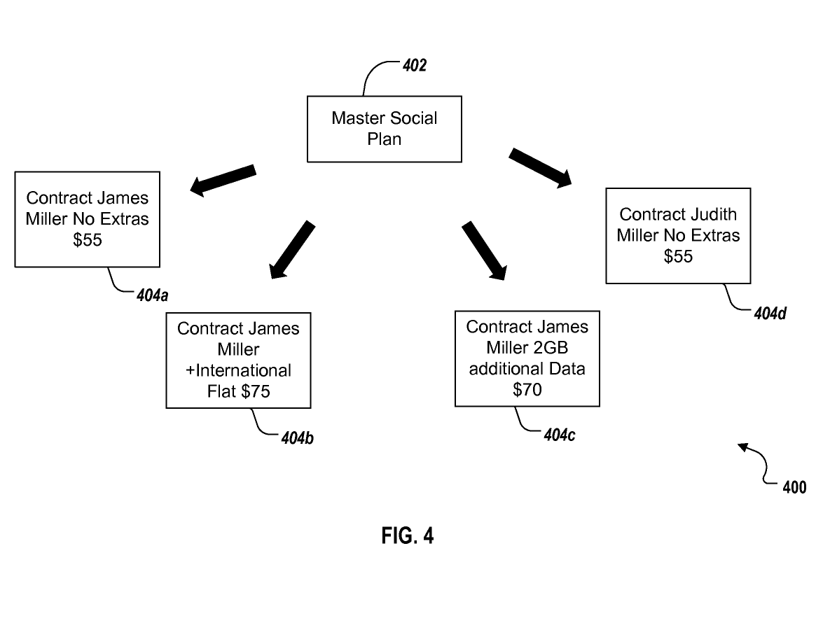

FIG. 4 illustrates an use-case example architecture 400 of a master social plan 402 and dependent social plans 404a, 404b, 404c, 404d (collectively referred to as dependent social plans 404). For example, the architecture 400 can be associated with a wireless telecommunications service. The master social plan 402 can include characteristics of unlimited voice call and 500 megabytes of data per month. Additionally, the master social plan 402 can be associated with a pricing structure. For example, the master social plan 402 can be initially associated with a $70 per month pricing structure. However, as additional other users are associated with the master social plan 402 via the dependent social plans 404, the pricing structure associated with the master social plan 402 and each dependent social plan 404 is decreased. For example, for each additional dependent social plan 404 that is associated with the master social plan 402, a $5 discount is applied to the pricing structure of each of the master social plan 402 and the dependent social plans 404. In some examples, for each additional dependent social plan 404 that is associated with the master social plan 402, a $5 discount is applied to the pricing structure of only the master social plan 402.

In some examples, the discount applied to the pricing structure can be limited to a predefined number, e.g., after the 4^{th} dependent social plan 404 is associated with the master social plan 402, additional discounts are not applied to the pricing structure. In the illustrated example, the pricing structure associated with the master social plan 402 and the dependent social plans 404 is decreased by $15 as a result of the dependent social plans 404 being associated with the master social plan 402, resulting in a pricing structure of $55 for the aforementioned plan (unlimited voice calls/500 megabytes of data per month).

Additionally, each other user associated with each dependent social plan 404 is able to provide personalized settings associated with the respective dependent social plan 404. In some examples, each dependent plan can include modification to the characteristics of the master social plan 402. For example, dependent social plan 404b is associated with a customized setting of an International voice option at a pricing structure of $20 per month, resulting in a total pricing structure of $75 for dependent social plan 404b. Also, for example, dependent social plan 404c is associated with a customized setting of an additional data plan of 2 gigabytes per month at a pricing structure of $15 per month, resulting in a total pricing structure of $70 per month. Dependent social plans 404a and 4024 include no customizable settings, and thus, are substantially the same as the master social plan 402 and the pricing structure of the master social plan 402. In some examples, cancellation of a dependent social plan 404 by an associated user may result in increase of the total pricing structure associated with the particular dependent social plan 404, as well as the remaining dependent social plans 404 and the master social plan 402.

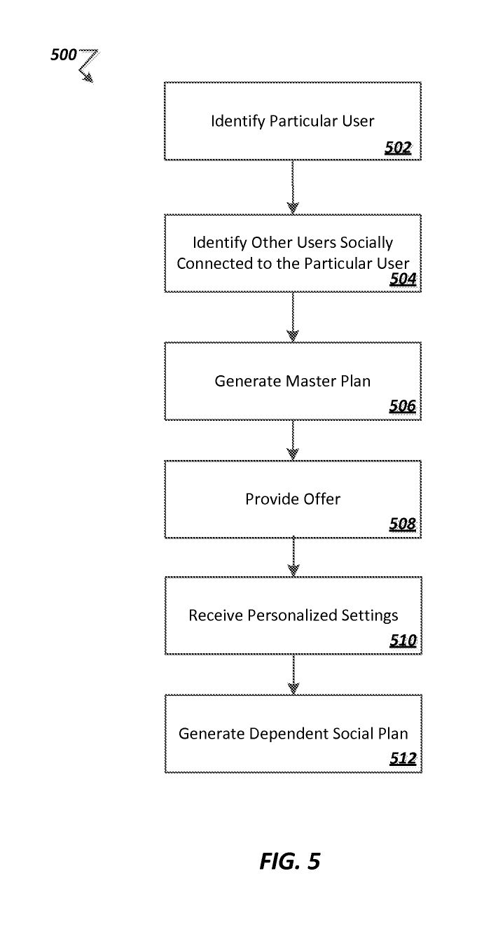

FIG. 5 illustrates a flow chart of a method for providing social networking based offers. For clarity of presentation, the description that follows generally describes method 500 in the context of FIGS. 1-3. For example, as illustrated, particular steps of the method 500 may be performed on or at an enterprise system, cloud-based system, and/or on-demand system, while other particular steps may be performed on or at a client system or on-premise system. However, method 500 may be performed, for example, by any other suitable system, environment, software, and hardware, or a combination of systems, environments, software, and hardware as appropriate.

At operation 502, a particular user is identified that is a customer of service provider. At operation 504, one or more other users are identified that are socially connected to the particular user through at least one social network. In some examples, the particular user identifies the one or more other users through other methods, e.g., email, text message, applications, etc. At operation 506, a master social plan is generated, by the service provider, for the particular user and a subset of the one or more other users. In some examples, the master social plan identifying a business model between (i) each of the particular user and the subset of the one or more other users and (ii) the service provider. At operation 508, an offer associated with the master social plan is provided to the subset of the one or more other users. In some examples, the offer includes (i) the master social plan and (ii) one or more personalized options. In some examples, the offer is provided through the at least one social network. At operation 510, in response to providing the offer, one or more personalized settings associated with the master social plan are received from one or more other users of the subset of the one or more other users. At operation 512, a dependent social plan is generated, for each of the one or more other users of the subset of the one or more other users, based on (i) the master social plan and (ii) the one or more personalized settings for the other user. In some examples, the one or more personalized settings includes one or more modifications of one or more characteristics of the master social plan. In some examples, the dependent social plan is connected to the master social plan. As such, changes to one or more of the dependent social plan and the master social plan can affect the remaining dependent social plan and the master plan.

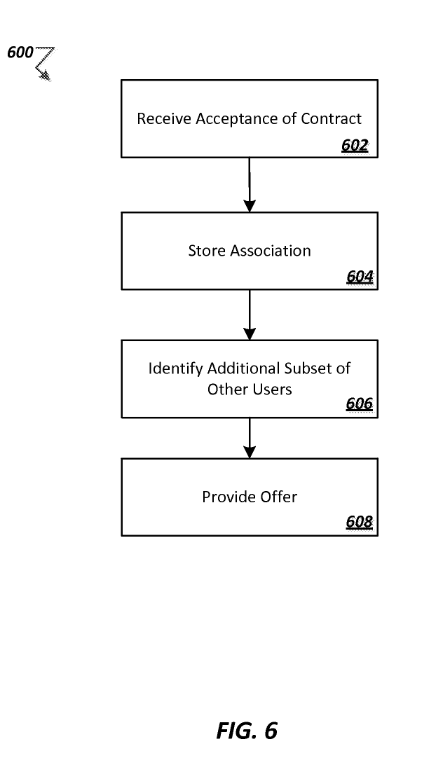

FIG. 6 illustrates a flow chart of a method for providing closed-loop social networking based offers. For clarity of presentation, the description that follows generally describes method 600 in the context of FIGS. 1-3. For example, as illustrated, particular steps of the method 600 may be performed on or at an enterprise system, cloud-based system, and/or on-demand system, while other particular steps may be performed on or at a client system or on-premise system. However, method 600 may be performed, for example, by any other suitable system, environment, software, and hardware, or a combination of systems, environments, software, and hardware as appropriate.

At operation 602, an acceptance of a contract is received, from each of the one or more other users of the subset of the one or more other users, associated with the offer between the other user and the service provider. At operation 604, an association between each of the one or more other users of the subset of the one or more other users and the particular user is stored, in a database. In some examples, the association indicates the acceptance of the contract associated with the offer. At operation 606, an additional subset of the one or more other users that are socially connected to the particular user is identified. In some examples, the additional subset of the one or more other users exclusive of the one or more other users of the subset of the one or more other users that accepted the contract associated with the offer. At operation 608, the offer associated with the master social plan is provided to the additional subset of the one or more other users.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, e.g., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order (e.g., FIGS. 4-9), this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results. Accordingly, the above description of example implementations does not define or constrain this disclosure. Other changes, substitutions, and alterations are also possible without departing from the spirit and scope of this disclosure.

What is claimed is:

1. A computer-implemented method, comprising:
identifying a particular user that is a customer of a service provider;
identifying one or more other users that are socially connected to the particular user through at least one social network;
generating, by the service provider, a master social plan for the particular user and a subset of the one or more other users, the master social plan identifying a business model between (i) each of the particular user and the subset of the one or more other users and (ii) the service provider; and
providing an offer associated with the master social plan to the subset of the one or more other users.

2. The computer-implemented method of claim 1, further comprising:
in response to providing the offer, receiving, from one or more other users of the subset of the one or more other users, one or more personalized settings associated with the master social plan; and
generating, for each of the one or more other users of the subset of the one or more other users, a dependent social plan based on (i) the master social plan and (ii) the one or more personalized settings for the other user.

3. The computer-implemented method of claim 2, wherein the one or more personalized settings associated with a first other user of the one or more other users of the subset of the one or more other users is different from the one or more personalized settings associated with a second other user of the one or more other users of the subset of the one or more other users.

4. The computer-implemented method of claim 3, wherein generating the dependent social plan further comprises:
generating, for the first other user, a first dependent social plan based on (i) the master social plan and (ii) the one or more personalized settings associated with the first other user;
generating, for the second other user, a second dependent social plan based on (i) the master social plan and (ii) the one or more personalized settings associated with the second other user,
wherein the first dependent social plan is different from the second dependent social plan.

5. The computer-implemented method of claim 2, wherein the one or more personalized settings associated with the master social plan comprises one or more modifications of one or more characteristics of the master social plan.

6. The computer-implemented method of claim 2, further comprising:
receiving, from each of the one or more other users of the subset of the one or more other users, an acceptance of a contract associated with the offer between the other user and the service provider; and
storing, in a database, an association between each of the one or more other users of the subset of the one or more other users and the particular user, the association indicating the acceptance of the contract associated with the offer.

7. The computer-implemented method of claim 6, further comprising:
identifying an additional subset of the one or more other users that are socially connected to the particular user, the additional subset of the one or more other users exclusive of the one or more other users of the subset of the one or more other users that accepted the contract associated with the offer; and
providing the offer associated with the master social plan to the additional subset of the one or more other users.

8. The computer-implemented method of claim 2, further comprising:
identifying a number of generated dependent social plans; and
associating a financial discount with the master social plan based on the number of generated dependent social plans.

9. The computer-implemented method of claim 1, wherein the offer includes (i) the master social plan and (ii) one or more personalization options.

10. The computer-implemented method of claim 1, wherein identifying the one or more other users that are socially connected to the particular user through the at least one social network further comprises:
identifying a social network graph associated with the particular user and corresponding to the at least one social network; and
identifying the one or more other users that are socially connected to the particular user based on the social network graph.

11. The computer-implemented method of claim 1, wherein providing the offer associated with the master social plan to the subset of the one or more other users further comprises providing the offer through the at least one social network.

12. The computer-implemented method of claim 11, wherein providing the offer through the at least one social network comprises modifying a social network stream of items of digital content to include an additional item of digital content associated with the offer.

13. The computer-implemented method of claim 1, wherein the customer is a current customer of the service provider.

14. The computer-implemented method of claim 1, wherein the customer is a potential customer of the service provider.

15. The computer-implemented method of claim 14, further comprising:
providing the offer associated with the master plan to the potential customer of the service provider.

16. The computer-implemented method of claim 1, wherein identifying the one or more other users that are socially connected to the particular user through the at least one social network further comprises:
identifying, for each other user of the one or more other users, a social score of each other user with respect to the particular user;
comparing the social score of each other user of the one or more other users with a social threshold score; and
based on the comparing, identifying the subset of the one or more other users having a social score greater than the social threshold score.

17. The computer-implemented method of claim 16, wherein the social score, for each other user of the one or more other users, is based on a number of social interactions between the other user and the particular user and a type of the social interactions between the other user and the particular user.

18. A computer program product encoded on a non-transitory storage medium, the product comprising non-transitory, computer readable instructions for causing one or more processors to perform operations comprising:
identifying a particular user that is a customer of a service provider;
identifying one or more other users that are socially connected to the particular user through at least one social network;
generating, by the service provider, a master social plan for the particular user and a subset of the one or more other users, the master social plan identifying a business model between (i) each of the particular user and the subset of the one or more other users and (ii) the service provider; and
providing an offer associated with the master social plan to the subset of the one or more other users.

19. A system of one or more computers configured to perform operations comprising:
identifying a particular user that is a customer of a service provider;
identifying one or more other users that are socially connected to the particular user through at least one social network;
generating, by the service provider, a master social plan for the particular user and a subset of the one or more other users, the master social plan identifying a business model between (i) each of the particular user and the subset of the one or more other users and (ii) the service provider; and
providing an offer associated with the master social plan to the subset of the one or more other users.
